(19) United States
(12) Patent Application Publication
(10) Pub. No.: US 2018/0114200 A1
(43) Pub. Date: Apr. 26, 2018

(54) ROOT CAUSE ANALYSIS OF VEHICULAR ISSUES FROM USER REVIEWS

(71) Applicant: International Business Machines Corporation, Armonk, NY (US)

(72) Inventors: Vijay Kumar Ananthapur Bache, Karnataka (IN); Vijay Ekambaram, Tamilnadu (IN); Arun Nagarajan, Karnataka (IN); Saravanan Sadacharam, Chennai (IN); Rengia Ramaiyan Vasudevan, Karnataka (IN)

(21) Appl. No.: 15/333,646

(22) Filed: Oct. 25, 2016

(51) Int. Cl. G06Q 10/00; G06F 17/30; G07C 5/00; G07C 5/08

(52) U.S. Cl. CPC G06Q 10/20; G06F 17/30705; G06Q 50/01; G07C 5/08; G07C 5/008

(57) ABSTRACT

Root cause analysis of issues relating to a vehicle of interest using user reviews from media and service centers of vehicles to link sensor data to the last time that class of vehicles came in for service to determine the issue and the resolution. The root cause analysis includes identifying potential user reviews from a source regarding the vehicle of interest; identifying issues regarding the vehicle of interest in the user reviews; identifying a set of sensors of the vehicle of interest which relate to the identified issues from the user reviews; comparing and correlating sensor values from the set of sensors of the vehicle of interest belonging to users posting a same issue to identify a common set of sensors observing the same issue in the vehicle of interest; analyzing a root cause for each identified issue; and sending the root cause for the identified issue to a user.

### BACKGROUND

The present invention relates to root cause analysis, and more specifically to root cause analysis of vehicular issues based on user reviews.

Automotive companies have the opportunity to leverage new sources of data to accelerate product design, improve vehicle performance and enhance the driver experience. These sources of data include: internally generated enterprise data; externally available, unstructured review data such as product review in online forums, social media and blogs; service and maintenance notes or history; sensor generated data from sensors, onboard communications, GPS, telematics generating data including miles per hour, miles per gallon, revolutions per minute, oil pressure, water temperature, engine temperature, tire wear, oil viscosity, fuel efficiency, etc. The amount of data collected from and about a vehicle is very large.

Currently root cause analysis is based on a correlation between service histories and the collected sensor data. However, service notes/history are taken only during service time of the vehicle which has to be paid by the end-users, which leads to only a small number of instances getting reported.

Users will often review their vehicle online through forums, reporting issues they may be having with their vehicle. Due to the unstructured nature of the reviews provided by the end user, the data in the reviews is very noisy and redundant. Furthermore, the reviews do not contain core technical details which are required for root cause analysis.

### SUMMARY

According to one embodiment of the present invention, a method of root cause analysis of issues relating to a vehicle of interest is disclosed. The method comprising the steps of: a computer identifying potential user reviews from a source regarding the vehicle of interest; the computer identifying issues regarding the vehicle of interest in the potential user reviews; the computer identifying a set of sensors of the vehicle of interest which relate to the identified issues from the potential user reviews; the computer comparing and correlating sensor values from the set of sensors of the vehicle of interest belonging to users posting a same issue to identify a common set of sensors observing the same issue in the vehicle of interest; the computer analyzing a root cause for each identified issue; and the computer sending the root cause for the identified issue to a user.

According to another embodiment of the present invention a computer program product for root cause analysis of issues relating to a vehicle of interest is disclosed. The computer program product including a computer comprising at least one processor, one or more memories, one or more computer readable storage media. The computer program product comprising a computer readable storage medium having program instructions embodied therewith, the program instructions executable by the computer to perform a method comprising: identifying, by the computer, potential user reviews from a source regarding the vehicle of interest; identifying, by the computer, issues regarding the vehicle of interest in the potential user reviews; identifying, by the computer, a set of sensors of the vehicle of interest which relate to the identified issues from the potential user reviews; comparing and correlating, by the computer, sensor values from the set of sensors of the vehicle of interest belonging to users posting a same issue to identify a common set of sensors observing the same issue in the vehicle of interest; analyzing, by the computer, a root cause for each identified issue; and sending, by the computer, the root cause for the identified issue to a user.

According to another embodiment of the present invention a computer system for root cause analysis of issues relating to a vehicle of interest comprising a computer comprising at least one processor, one or more memories, one or more computer readable storage media having program instructions executable by the computer to perform program instructions is disclosed. The program instructions comprising: identifying, by the computer, potential user reviews from a source regarding the vehicle of interest; identifying, by the computer, issues regarding the vehicle of interest in the potential user reviews; identifying, by the computer, a set of sensors of the vehicle of interest which relate to the identified issues from the potential user reviews; comparing and correlating, by the computer, sensor values from the set of sensors of the vehicle of interest belonging to users posting a same issue to identify a common set of sensors observing the same issue in the vehicle of interest; analyzing, by the computer, a root cause for each identified issue; and sending, by the computer, the root cause for the identified issue to a user.

### BRIEF DESCRIPTION OF THE DRAWINGS

FIG. 1 depicts an exemplary diagram of a possible data processing environment in which illustrative embodiments may be implemented.

FIG. 2 shows a flow diagram of a method of root cause analysis of vehicular issues based on user reviews.

FIG. 3 shows a flow diagram of a method of identifying potential user reviews.

FIG. 4 shows a flow diagram of a method of identifying issues from the user reviews.

FIG. 5 shows a flow diagram of a method of identifying a set of sensors which relate to each of the identified issues.

FIG. 6 shows a flow diagram of a method of comparing and correlating sensor values among users posting on the same identified issue.

FIG. 7 shows a flow diagram of a method of analyzing a root cause for each of the identified issues.

FIG. 8 illustrates internal and external components of a mobile device and a personal imaging device and a server computer in which illustrative embodiments may be implemented.

### DETAILED DESCRIPTION

It will be recognized in an embodiment of the present invention that user reviews from media and manufactures/service centers of automobiles are used to link sensor data to the last time either that vehicle or that class of vehicles that have come in for service to determine the issue and support the resolution.

It will also be recognized that in an embodiment of the present invention an algorithm is used to link social comments of a vehicle owner with sensor data collected during service and determining the core issues.

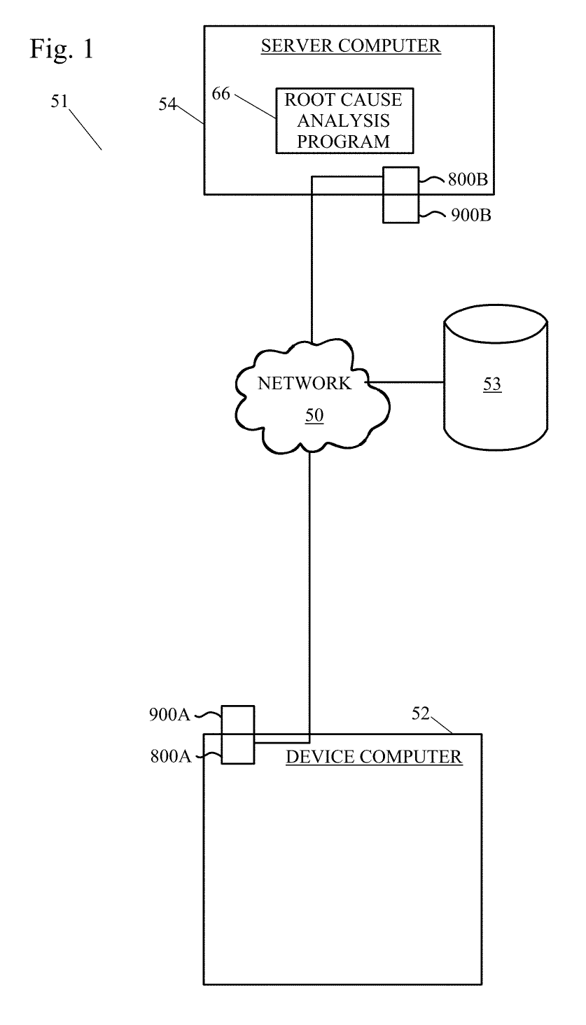

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

In the depicted example, device computer 52, repository 53, and server computer 54 connect to network 50. In other exemplary embodiments, network data processing system 51 may include additional device computers, storage devices, server computers, and other devices not shown.

The repository 53 may contain, but is not limited to: vehicular enterprise data which may be maintained by a vehicular dealer or service provider, or the vehicular company, service history of vehicles, associated target sensor data logs, users/owners of the vehicles, and users registered to participate in root cause analysis.

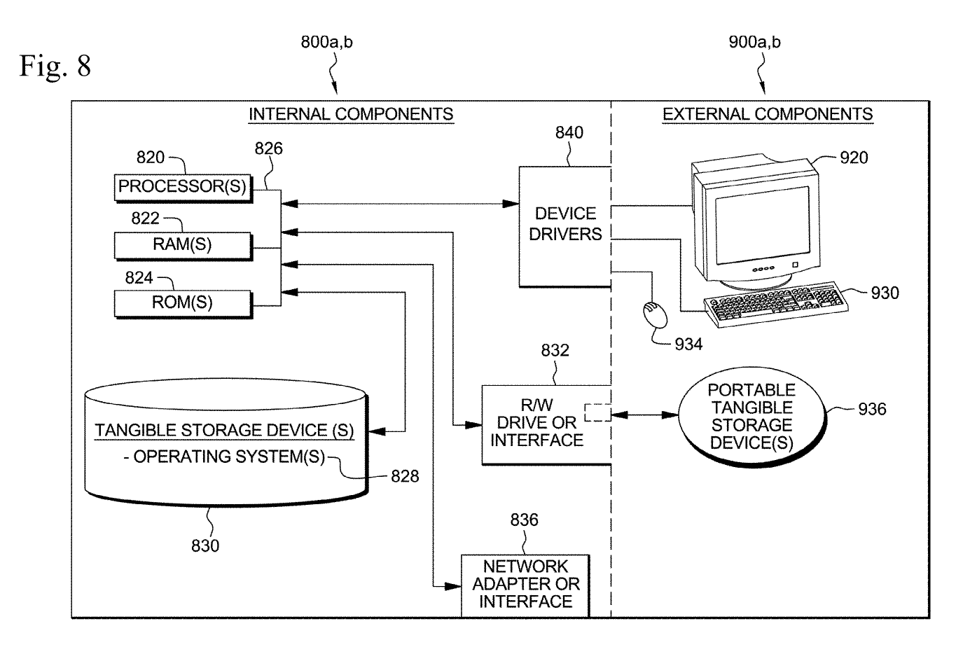

A device computer includes a set of internal components 800a and a set of external components 900a, further illustrated in FIG. 8. The device or client computer 52 may be a mobile device, smart phone, laptop, personal computer, or other electronic device. The device computer 52 may contain an interface. The interface can be, for example, a command line interface, a graphical user interface (GUI), a web user interface (WUI), or a touch user interface (TUI).

Server computer 54 includes a set of internal components 800b and a set of external components 900b illustrated in FIG. 8. Server computer 54 may contain an interface. The interface can be, for example, a command line interface, a graphical user interface (GUI), a touch user interface (TUI) or a web user interface (WUI). The server computer 54 may also include a root cause analysis program 66. In the depicted example, server computer 54 provides information, such as boot files, operating system images, and applications to the device computer 52. Server computer 54 can compute the information locally or extract the information from other computers on network 50.

Program code and programs such as the root cause analysis program 66 may be stored on at least one of one or more computer-readable tangible storage devices 830 shown in FIG. 8, on at least one of one or more portable computer-readable tangible storage devices 936 as shown in FIG. 8, or on storage unit or repository 53 connected to network 50, or may be downloaded to a computer, such as device computer 52 or server computer 54, for use.

For example, program code and programs such as root cause analysis program 66 may be stored on at least one of one or more storage devices 830 on server computer 54 and downloaded to device computer 52 over network 50 for use on device computer 52. Alternatively, server computer 54 can be a web server, and the program code, and programs such as root cause analysis program 66 may be stored on at least one of the one or more storage devices 830 on server computer 54 and accessed on device computers 52. In other exemplary embodiments, the program code, and programs such as root cause analysis program 66 may be stored on at least one of one or more computer-readable storage devices 830 on device computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

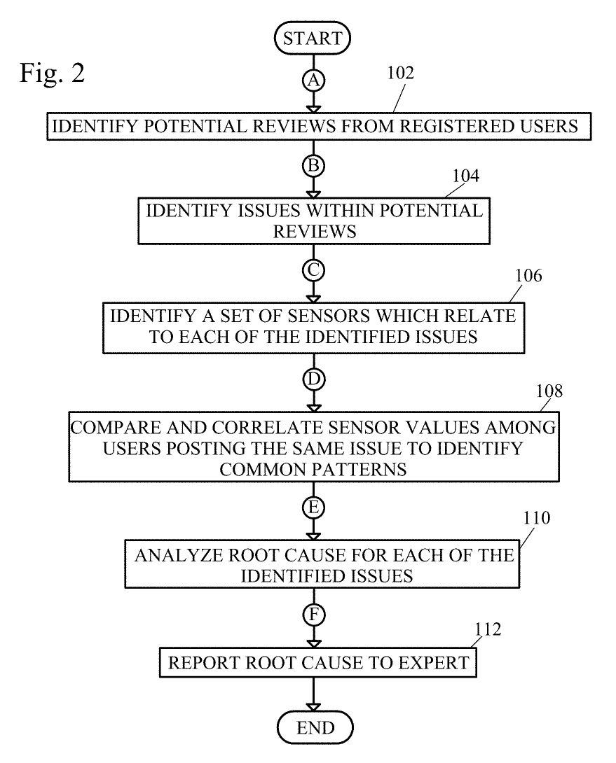

It should be noted that prior to FIG. 2, users would need to register with the root cause analysis program 66 and the user registration including their associated vehicles may be maintained enterprise data repository.

FIG. 2 shows a flow diagram of an overview of a method of root cause analysis of vehicular issues based on user reviews.

In a first step, the root cause analysis program 66 identifies potential user reviews from registered users (step 102).

The root cause analysis program 66 then identifies issues from the identified reviews relating to the vehicle of interest (step 104).

The root cause analysis program then identifies a set of sensors of the vehicle which relate to each of the identified issues for the vehicle of interest (step 106). Examples of sensors of the vehicle may be, but are not limited to: air flow meter, air fuel ratio meter, engine coolant temperature sensor, crankshaft position sensor, crank sensor Hall effect sensor, knock sensor, Manifold Absolute Pressure sensor, Mass flow sensor, or mass airflow (MAF) sensor, Oxygen sensor, parking sensors, speed sensor, throttle position sensor, tire-pressure monitoring sensor, torque sensor, transmission fluid temperature sensor, turbine speed sensor (TSS), or input speed sensor (ISS), variable reluctance sensor, vehicle speed sensor (VSS), water sensor or water-in-fuel sensor, and wheel speed sensor.

The root cause analysis program 66 compares and correlates sensor values from the sensors of the vehicle of interest among registered users posting the same semantic issues to identify common patterns (step 108).

The root cause analysis program 66 then analyzes the root cause for each of the identified issues (step 110) and the root cause is reported to an expert user for confirmation of the root cause of the issue (step 112) and the method ends.

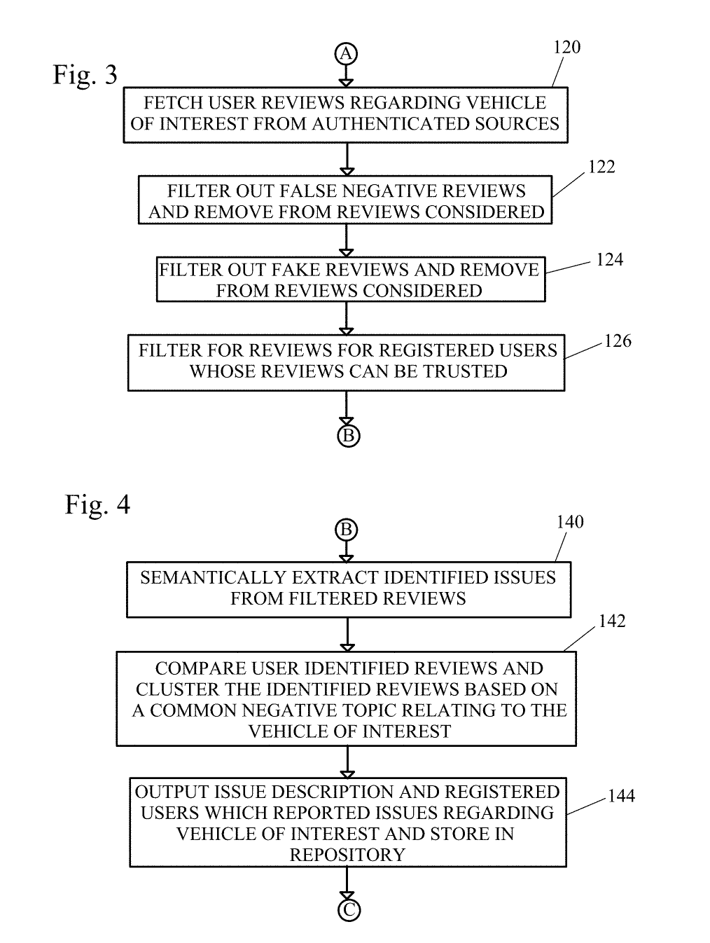

FIG. 3 shows a method of identifying potential user reviews from registered users (step 102).

User reviews regarding the vehicle of interest are fetched from authenticated sources (step 120). The authenticated sources are sources which have been authenticated as containing user reviews of vehicles. The authenticated sources may be car websites which have been registered with the root cause analysis program 66 and have registered users.

False negative reviews and the fake reviews are filtered out from the user reviews fetched from the authenticated sources (steps 122, 124). For example, a negative review regarding a vehicle may be filtered out by collecting external environmental context data, correlating an attribute of the vehicle being criticized with the external environmental context data as a function of the number of times of the occurrence of the criticized attribute of the vehicle within the negative review, determining a degree of the likelihood that the criticized attribute is the principal cause of the negative review and determining that the negative review is a false negative review if the value of the degree of likelihood that the correlated attribute of the external environmental context data is the principal cause is higher than the determined degree of likelihood that the criticized attribute of the information technology item is the principal cause.

The remaining reviews are then filtered for potential registered users whose reviews can be trusted (step 126), resulting in meaningful, authentic reviews from trusted, registered users and the method continues to step 104. Filtering for potential registered users whose reviews can be trusted may use a mechanism to determine the potential users based on their loyalty, information provided, falseness and other factors, such as using multiple qualitative measures to access and rank a collection of reviews.

FIG. 4 shows a method of identifying issues from the identified reviews relating to the vehicle of interest (step 104).

From the identified reviews, issues are semantically extracted, for example by the route cause analysis program 66 (step 140). The semantic extraction preferably includes semantic capture and domain context capture and does not include traditional keyword based extraction, as every user uses different phrases to express information, rendering traditional keyword based extraction not useful. Semantic text analytics compare texts based on the underlying meaning and is not based keywords. The accuracy of the semantic extraction may be increased through training.

For example, if a first review states “Car speed not satisfactory” and a second review states, “acceleration is not raising high”, no common words are present between reviews 1 and 2, but reviewers are attempting to convey the same meaning, even though the term “acceleration” has different meaning in different contexts. In a vehicle context, acceleration refers to speed.

A deep learning approach may also be used for semantic extraction.

User identified reviews are then compared and clustered based on a common negative topic regarding the vehicle of interest (step 142). An issue description regarding the vehicle of interest and the registered users which reported the issues regarding the vehicle of interest are stored in a repository (step 144), for example repository 53 and the method continues to step 106.

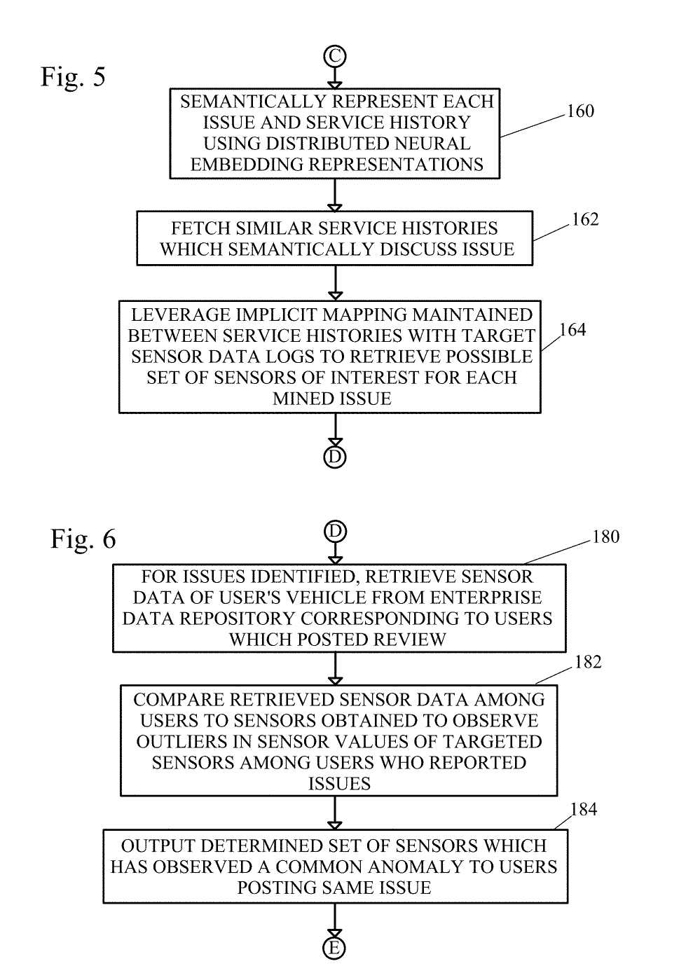

FIG. 5 shows a method of identifying a set of sensors which relate to each of the identified issues for the vehicle of interest (step 106). Examples of sensors of the vehicle may be, but are not limited to: air flow meter, air fuel ratio meter, engine coolant temperature sensor, crankshaft position sensor, crank sensor Hall effect sensor, knock sensor, Manifold Absolute Pressure sensor, Mass flow sensor, or mass airflow (MAF) sensor, Oxygen sensor, parking sensors, speed sensor, throttle position sensor, tire-pressure monitoring sensor, torque sensor, transmission fluid temperature sensor, turbine speed sensor (TSS), or input speed sensor (ISS), variable reluctance sensor, vehicle speed sensor (VSS), water sensor or water-in-fuel sensor, and wheel speed sensor. Different combinations of sensors may represent a set of vehicle sensors.

For each issue corresponding to a negative topic, the service history of the vehicle is semantically compared to the issue description extracted from the service histories related to the description of the negative topic and each issue corresponding to a negative topic is semantically represented with a service history for the vehicle of interest using a distributed neural embedded representation (step 160). The distributed neural embedded representation may be processed through Word2vec or other distributed neural embedded representations. The distributed neural embedded representation may use a two-layer neural network which is trained to reconstruct linguistic contexts of words and provide a distributed representation of a word. Each unique word within the text may be assigned a corresponding vector in the space. Word vectors are then positioned in the vector space such that words that share common contexts from the text are located in close proximity to one another in the space.

Next, similar service histories which semantically discuss the negative topic or issue are fetched from an automotive data repository (step 162), which may be an enterprise repository associated with the make of the vehicle.

The implicit mapping maintained between the service histories and vehicular sensor data logs are leveraged to retrieve a possible set of vehicular sensors of interest for each negative topic or issue (step 164) and the method continues to step 108.

For example, based on ignition cycle of a cylinder of the engine, ignition spark rate and revolutions per minute (RPM) of the engine as measured by vehicle sensors in multiple vehicles, an engine ignition misfire may be identified.

FIG. 6 shows a method comparing and correlating sensor values from the vehicle of interest among registered users posting the same semantic issues to identify common patterns (step 108).

For each negative topic or issue identified, sensor data of a user's vehicle from the enterprise data repository, corresponding to users which posted reviews, are retrieved (step 180).

The retrieved sensor data is compared to sensor data obtained of a vehicle reporting the negative topic or issue to observe whether any outliers in the sensor data of the targeted sensors are present among the registered users who reported the negative topic (step 182).

A determined set of sensors which has observed a common anomaly from registered users reporting the same negative topic or issue is outputted (step 184) and the method continues to step 110.

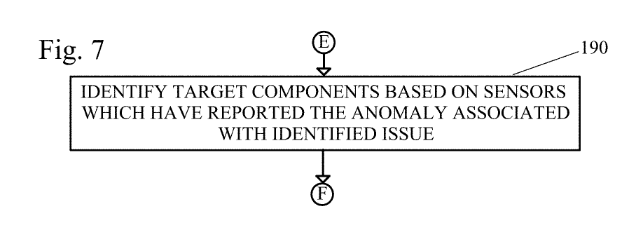

FIG. 7 shows a method of analyzing the root cause for each of the identified issues (step 110). Using predefined rules or a description set, target components are identified based on the sensors which have reported the anomaly associated with the negative topic or issue (step 190).

FIG. 8 illustrates internal and external components of device computer 52 and server computer 54 in which illustrative embodiments may be implemented. In FIG. 8, device computer 52 and server computer 54 include respective sets of internal components 800a, 800b and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and a root cause analysis program 66 are stored on one or more of the computer-readable tangible storage devices 830 for execution by one or more of the processors 820 via one or more of the RAMs 822 (which typically include cache memory). In the embodiment illustrated in FIG. 8, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Root cause analysis program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Root cause analysis program 66 can be downloaded to the device computer 52 and server computer 54 from an external computer via a network (for example, the Internet, a local area network or other, wide area network) and network adapter or interface 836. From the network adapter or interface 836, root cause analysis program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 934. Each of the sets of internal components 800a, 800b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Root cause analysis program 66 can be written in various programming languages including low-level, high-level, object-oriented or non object-oriented languages. Alternatively, the functions of a root cause analysis program 66 can be implemented in whole or in part by computer circuits and other hardware (not shown).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of root cause analysis of issues relating to a vehicle of interest comprising the steps of:
a computer identifying potential user reviews from a source regarding the vehicle of interest;
the computer identifying issues regarding the vehicle of interest in the potential user reviews;
the computer identifying a set of sensors of the vehicle of interest which relate to the identified issues from the potential user reviews;
the computer comparing and correlating sensor values from the set of sensors of the vehicle of interest belonging to users posting a same issue to identify a common set of sensors observing the same issue in the vehicle of interest;
the computer analyzing a root cause for each identified issue; and
the computer sending the root cause for the identified issue to a user.

2. The method of claim 1, wherein the step of the computer identifying the potential user reviews from the source regarding the vehicle of interest further comprises the steps of:
the computer retrieving the potential user reviews regarding the vehicle of interest from an authenticated source;
the computer filtering the potential user reviews to remove false negative reviews;
the computer filtering the potential user reviews to remove fake reviews; and
the computer filtering remaining potential user reviews for reviews by users whose reviews are trusted.

3. The method of claim 1, wherein the step of the computer identifying issues regarding the vehicle of interest in the potential user reviews further comprises the steps of:
the computer semantically extracting identified issues from the identified potential user reviews;
the computer comparing identified potential user reviews to cluster the identified potential user reviews based on a common negative topic relating to the vehicle of interest; and
the computer outputting an issue description and user which reported the identified issue regarding the vehicle of interest.

4. The method of claim 1, wherein the step of the computer identifying the set of sensors of the vehicle of interest which relate to the identified issues from the potential user reviews further comprises the steps of:
the computer semantically representing each identified issue and service history of the vehicle of interest with the identified issue;
the computer retrieving similar service histories of vehicles which semantically discuss the identified issue; and
the computer leveraging an implicit mapping maintained between the service history and target sensor data of the vehicles of interest to retrieve at least one possible set of sensors of interest for each identified issue in the vehicle of interest.

5. The method of claim 4, wherein the computer semantically represents each identified issue and service history of the vehicle of interest using a distributed neural embedded representation.

6. The method of claim 1, wherein the step of the computer comparing and correlating sensor values from the set of sensors of the vehicles of interest belonging to users posting the same issue to identify a common set of sensors observing the same issue in the vehicle of interest further comprises the steps of for each issue identified:
the computer retrieving sensor data of the user's vehicle of interest from an enterprise data repository corresponding to users which posted reviews;
the computer comparing the retrieved sensor data among users to determine whether outlier data is present; and
the computer determining a set of sensors which has observed a common anomaly to users posting the same identified issue.

7. The method of claim 1, wherein the step of the computer analyzing a root cause for each identified issue further comprises the step of: the computer identifying target components of the vehicle of interest based on sensors which reported a common anomaly associated with the identified issue.

8. A computer program product for root cause analysis of issues relating to a vehicle of interest, a computer comprising at least one processor, one or more memories, one or more computer readable storage media, the computer program product comprising a computer readable storage medium having program instructions embodied therewith, the program instructions executable by the computer to perform a method comprising:
identifying, by the computer, potential user reviews from a source regarding the vehicle of interest;
identifying, by the computer, issues regarding the vehicle of interest in the potential user reviews;
identifying, by the computer, a set of sensors of the vehicle of interest which relate to the identified issues from the potential user reviews;
comparing and correlating, by the computer, sensor values from the set of sensors of the vehicle of interest belonging to users posting a same issue to identify a common set of sensors observing the same issue in the vehicle of interest;
analyzing, by the computer, a root cause for each identified issue; and
sending, by the computer, the root cause for the identified issue to a user.

9. The computer program product of claim 8, wherein the program instructions of identifying, by the computer, the potential user reviews from the source regarding the vehicle of interest further comprises the program instructions of:
retrieving, by the computer, the potential user reviews regarding the vehicle of interest from an authenticated source;
filtering, by the computer, the potential user reviews to remove false negative reviews;
filtering, by the computer, the potential user reviews to remove fake reviews; and
filtering, by the computer, remaining potential user reviews for reviews by users whose reviews are trusted.

10. The computer program product of claim 8, wherein the program instructions of identifying, by the computer, issues regarding the vehicle of interest in the potential user reviews further comprises the program instructions of:
semantically, by the computer, extracting identified issues from the identified potential user reviews;
comparing, by the computer, identified potential user reviews to cluster the identified potential user reviews based on a common negative topic relating to the vehicle of interest; and
outputting, by the computer, an issue description and user which reported the identified issue regarding the vehicle of interest.

11. The computer program product of claim 8, wherein the program instruction of identifying, by the computer, the set of sensors of the vehicle of interest which relate to the identified issues from the potential user reviews further comprises the program instructions of:
semantically, by the computer, representing each identified issue and service history of the vehicle of interest with the identified issue;
retrieving, by the computer, similar service histories of vehicles which semantically discuss the identified issue; and
leveraging, by the computer, an implicit mapping maintained between the service history and target sensor data of the vehicles of interest to retrieve at least one possible set of sensors of interest for each identified issue in the vehicle of interest.

12. The computer program product of claim 11, wherein semantically, by the computer, represents each identified issue and service history of the vehicle of interest using a distributed neural embedded representation.

13. The computer program product of claim 8, wherein the program instructions of comparing and correlating, by the computer, sensor values from the set of sensors of the vehicles of interest belonging to users posting the same issue to identify a common set of sensors observing the same issue in the vehicle of interest further comprises the program instructions for each issue identified:
retrieving, by the computer, sensor data of the user's vehicle of interest from an enterprise data repository corresponding to users which posted reviews;
comparing, by the computer, the retrieved sensor data among users to determine whether outlier data is present; and
determining, by the computer, a set of sensors which has observed a common anomaly to users posting the same identified issue.

14. The computer program product of claim 8, wherein the program instructions of analyzing, by the computer, a root cause for each identified issue further comprises the program instructions of: identifying, by the computer, target components of the vehicle of interest based on sensors which reported a common anomaly associated with the identified issue.

15. A computer system for root cause analysis of issues relating to a vehicle of interest comprising a computer comprising at least one processor, one or more memories, one or more computer readable storage media having program instructions executable by the computer to perform the program instructions comprising:
identifying, by the computer, potential user reviews from a source regarding the vehicle of interest;
identifying, by the computer, issues regarding the vehicle of interest in the potential user reviews;
identifying, by the computer, a set of sensors of the vehicle of interest which relate to the identified issues from the potential user reviews;
comparing and correlating, by the computer, sensor values from the set of sensors of the vehicle of interest belonging to users posting a same issue to identify a common set of sensors observing the same issue in the vehicle of interest;
analyzing, by the computer, a root cause for each identified issue; and
sending, by the computer, the root cause for the identified issue to a user.

16. The computer system of claim 15, wherein the program instructions of identifying, by the computer, the potential user reviews from the source regarding the vehicle of interest further comprises the program instructions of:
retrieving, by the computer, the potential user reviews regarding the vehicle of interest from an authenticated source;
filtering, by the computer, the potential user reviews to remove false negative reviews;
filtering, by the computer, the potential user reviews to remove fake reviews; and
filtering, by the computer, remaining potential user reviews for reviews by users whose reviews are trusted.

17. The computer system of claim 15, wherein the program instructions of identifying, by the computer, issues regarding the vehicle of interest in the potential user reviews further comprises the program instructions of:
semantically, by the computer, extracting identified issues from the identified potential user reviews;
comparing, by the computer, identified potential user reviews to cluster the identified potential user reviews based on a common negative topic relating to the vehicle of interest; and
outputting, by the computer, an issue description and user which reported the identified issue regarding the vehicle of interest.

18. The computer system of claim 15, wherein the program instruction of identifying, by the computer, the set of sensors of the vehicle of interest which relate to the identified issues from the potential user reviews further comprises the program instructions of:
semantically, by the computer, representing each identified issue and service history of the vehicle of interest with the identified issue;
retrieving, by the computer, similar service histories of vehicles which semantically discuss the identified issue; and
leveraging, by the computer, an implicit mapping maintained between the service history and target sensor data of the vehicles of interest to retrieve at least one possible set of sensors of interest for each identified issue in the vehicle of interest.

19. The computer system of claim 18, wherein semantically, by the computer, represents each identified issue and service history of the vehicle of interest using a distributed neural embedded representation.

20. The computer system of claim 15, wherein the program instructions of comparing and correlating, by the computer, sensor values from the set of sensors of the vehicles of interest belonging to users posting the same issue to identify a common set of sensors observing the same issue in the vehicle of interest further comprises the program instructions for each issue identified:
retrieving, by the computer, sensor data of the user's vehicle of interest from an enterprise data repository corresponding to users which posted reviews;
comparing, by the computer, the retrieved sensor data among users to determine whether outlier data is present; and
determining, by the computer, a set of sensors which has observed a common anomaly to users posting the same identified issue.
